(19) United States
(12) Patent Application Publication
(10) Pub. No.: US 2025/0350957 A1
(43) Pub. Date: Nov. 13, 2025

(54) DYNAMIC FREQUENCY SELECTION APPROACH FOR CELLULAR AND WI-FI SPECTRUM SHARING

(71) Applicant: QUALCOMM Incorporated, San Diego, CA (US)

(72) Inventors: Marco PAPALEO, Bologna (IT); Pierpaolo VALLESE, Pineto (IT); Aleksandar DAMNJANOVIC, Del Mar, CA (US); Tevfik YUCEK, San Jose, CA (US)

(21) Appl. No.: 18/661,984

(22) Filed: May 13, 2024

(51) Int. Cl. H04W 16/14; H04W 84/12

(52) U.S. Cl. CPC H04W 16/14; H04W 84/12

(57) ABSTRACT

This disclosure provides methods, components, devices, and systems for dynamic frequency selection approach for cellular and Wi-Fi spectrum sharing. In some examples, wireless local area network (WLAN) devices may operate in a shared frequency bandwidth based on monitoring for one or more signals from cellular devices. For example, a WLAN device detect may detect a broadcast signal via a first frequency bandwidth, and determine that the first frequency bandwidth is in use by one or more cellular networks. As such, the WLAN device may perform communication operations (e.g., WLAN operations) via a second frequency bandwidth different from the first frequency bandwidth, or a different channel of the first frequency bandwidth. If the WLAN device does not detect such a signal, the WLAN device may operate via the first frequency bandwidth, and the WLAN device may be configured to perform periodic monitoring of the first frequency bandwidth.

### TECHNICAL FIELD

This disclosure relates generally to wireless communication and, more specifically, to dynamic frequency selection for cellular and Wi-Fi spectrum sharing.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

In some systems, various wireless devices may use different portions of a frequency spectrum. For example, cellular devices (e.g., devices operating according to 3GPP-based procedures, such as a user equipment (UE) or a network entity) and wireless local area network (WLAN) devices (e.g., access points (APs) and wireless stations (STAs)) may operate using different portions of the frequency spectrum, which may avoid interference between these devices. In some examples, however, portions of the frequency spectrum may be shared between devices operating using different communication procedures. For example, some portions of the frequency spectrum may be used by both WLAN devices and cellular devices.

In accordance with examples as described herein, wireless devices, such as WLAN devices, may operate in a shared frequency bandwidth based on monitoring for one or more signals from cellular devices. For example, a WLAN device detect may detect a broadcast signal (e.g., a synchronization signal block (SSB)) or a beacon signal (e.g., an IEEE beacon signal) via a first frequency bandwidth, and determine that the first frequency bandwidth is in use by one or more cellular networks. As such, the WLAN device may perform communication operations (e.g., WLAN operations) via a second frequency bandwidth different from the first frequency bandwidth. In some examples, the WLAN device may operate in the second frequency bandwidth for a duration (e.g., a non-occupancy period) after detecting the signal, and the WLAN device may monitor for one or more signals after the expiration of such duration. If the WLAN device does not detect a signal associated with the use of the first frequency bandwidth by the one or more cellular networks, the WLAN device may operate via the first frequency bandwidth, and the WLAN device may be configured to perform periodic monitoring for signals from cellular devices while operating in the first frequency bandwidth.

A method for wireless communication by a WLAN device is described. The method may include monitoring, over a first duration, a first frequency bandwidth for one or more signals associated with use of the first frequency bandwidth by one or more cellular networks, determining whether a signal associated with use of the first frequency bandwidth by one or more cellular networks is present during the first duration, and performing communications based on the determination of whether the signal associated with use of the first frequency bandwidth by one or more cellular networks is present during the first duration.

A WLAN device is described. The WLAN device may include one or more memories storing processor-executable code and one or more processors coupled with the one or more memories. The one or more processors may be individually or collectively operable to execute the code to cause the WLAN device to monitor, over a first duration, a first frequency bandwidth for one or more signals associated with use of the first frequency bandwidth by one or more cellular networks, determine whether a signal associated with use of the first frequency bandwidth by one or more cellular networks is present during the first duration, and perform communications based on the determination of whether the signal associated with use of the first frequency bandwidth by one or more cellular networks is present during the first duration.

Another WLAN device is described. The WLAN device may include means for monitoring, over a first duration, a first frequency bandwidth for one or more signals associated with use of the first frequency bandwidth by one or more cellular networks, means for determining whether a signal associated with use of the first frequency bandwidth by one or more cellular networks is present during the first duration, and means for performing communications based on the determination of whether the signal associated with use of the first frequency bandwidth by one or more cellular networks is present during the first duration.

A non-transitory computer-readable medium storing code for wireless communication by a WLAN device is described. The code may include instructions executable by one or more processors to monitor, over a first duration, a first frequency bandwidth for one or more signals associated with use of the first frequency bandwidth by one or more cellular networks, determine whether a signal associated with use of the first frequency bandwidth by one or more cellular networks is present during the first duration, and perform communications based on the determination of whether the signal associated with use of the first frequency bandwidth by one or more cellular networks is present during the first duration.

Some examples of the method, WLAN devices, and non-transitory computer-readable medium described herein may further include operations, features, means, or instructions for performing the communications via the first frequency bandwidth based on an absence during the first duration of the signal associated with use of the first frequency bandwidth by one or more cellular networks.

Some examples of the method, WLAN devices, and non-transitory computer-readable medium described herein may further include operations, features, means, or instructions for monitoring, after a second duration has elapsed, for one or more additional signals associated with use of the first frequency bandwidth by one or more cellular networks, and determining whether to continue to perform the communications via the first frequency bandwidth based on whether an additional signal associated with use of the first frequency bandwidth by one or more cellular networks is present.

Some examples of the method, WLAN devices, and non-transitory computer-readable medium described herein may further include operations, features, means, or instructions for performing, for at least a third duration, the communications via a second frequency bandwidth different from the first frequency bandwidth based on a presence during the first duration of the signal associated with use of the first frequency bandwidth by one or more cellular networks.

Some examples of the method, WLAN devices, and non-transitory computer-readable medium described herein may further include operations, features, means, or instructions for monitoring, after the third duration has elapsed, the first frequency bandwidth for another one or more signals associated with use of the first frequency bandwidth by one or more cellular networks.

Some examples of the method, WLAN devices, and non-transitory computer-readable medium described herein may further include operations, features, means, or instructions for performing the communications via the second frequency bandwidth based on the signal associated with use of the first frequency bandwidth by one or more cellular networks having a received power that satisfies a threshold value.

Some examples of the method, WLAN devices, and non-transitory computer-readable medium described herein may further include operations, features, means, or instructions for detecting a periodicity between at least two signals associated with use of the first frequency bandwidth by one or more cellular networks, where performing the communications is based on whether the periodicity between the at least two signals indicates use of the first frequency bandwidth by one or more cellular networks.

Some examples of the method, WLAN devices, and non-transitory computer-readable medium described herein may further include operations, features, means, or instructions for performing the communications via the first frequency bandwidth for at most a fourth duration based on a presence during the first duration of the signal associated with use of the first frequency bandwidth by one or more cellular networks, and refraining from performing communications via the first frequency bandwidth after the fourth duration has elapsed.

In some examples of the method, WLAN devices, and non-transitory computer-readable medium described herein, the WLAN device is configured with a set of values corresponding to the first duration associated with a duration for the monitoring, a second duration associated with a time between monitoring occasions, a third duration associated with a non-occupancy period, a fourth duration associated with a time for closing a channel transmission, or any combination thereof.

Some examples of the method, WLAN devices, and non-transitory computer-readable medium described herein may further include operations, features, means, or instructions for adjusting the set of values based on a time of day, a current date, or both.

Some examples of the method, WLAN devices, and non-transitory computer-readable medium described herein may further include operations, features, means, or instructions for receiving a message indicating one or more updated values corresponding to the set of values, and updating the set of values based on reception of the message.

Some examples of the method, WLAN devices, and non-transitory computer-readable medium described herein may further include operations, features, means, or instructions for detecting the signal associated with use of the first frequency bandwidth by one or more cellular networks, where the signal indicates use of a first channel of the first frequency bandwidth by one or more cellular networks, and performing the communications via a second channel of the first frequency bandwidth based on detection of the signal.

In some examples of the method, WLAN devices, and non-transitory computer-readable medium described herein, the signal associated with use of the first channel of the first frequency bandwidth by one or more cellular networks indicates the use of the first channel of the first frequency bandwidth by one or more cellular networks by being transmitted over the first channel.

Some examples of the method, WLAN devices, and non-transitory computer-readable medium described herein may further include operations, features, means, or instructions for randomly selecting the second channel from among a set of channels of the first frequency bandwidth that excludes the first channel.

In some examples of the method, WLAN devices, and non-transitory computer-readable medium described herein, the signal associated with use of the first frequency bandwidth by one or more cellular networks is a cellular broadcast signal or a beacon signal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication system.

FIG. 2 shows an example of a system that supports dynamic frequency selection for cellular and Wi-Fi spectrum sharing.

FIGS. 3A and 3B shows examples of frequency diagrams that support dynamic frequency selection for cellular and Wi-Fi spectrum sharing.

FIG. 4 shows an example of a process flow that supports dynamic frequency selection for cellular and Wi-Fi spectrum sharing.

FIG. 5 shows a block diagram of an example wireless communication device that supports dynamic frequency selection for cellular and Wi-Fi spectrum sharing.

FIG. 6 shows a flowchart illustrating an example process that supports dynamic frequency selection for cellular and Wi-Fi spectrum sharing.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless access system (WAS), a radio local area network (RLAN), a wireless wide area network (WWAN), a wireless metropolitan area network (WMAN), a non-terrestrial network (NTN), or an internet of things (IoT) network.

In some systems, various wireless devices may use different portions of a frequency spectrum. For example, cellular devices (e.g., devices operating according to 3GPP-based procedures, such as a user equipment (UE) or a network entity) and WLAN devices (e.g., access points (APs) and wireless stations (STAs)) may operate using different portions of the frequency spectrum, which may avoid interference between these devices. In some examples, however, portions of the frequency spectrum may be shared between devices operating using different communication procedures. For example, some portions of the frequency spectrum may be used by both WLAN devices and cellular devices.

In accordance with examples as described herein, wireless devices, such as WLAN devices, may operate in a shared frequency bandwidth based on monitoring for one or more signals from cellular devices. For example, a WLAN device detect may detect a broadcast signal (e.g., a synchronization signal block (SSB)) or a beacon signal (e.g., an IEEE beacon signal) via a first frequency bandwidth, and determine that the first frequency bandwidth is in use by one or more cellular networks. As such, the WLAN device may perform communication operations (e.g., WLAN operations) via a second frequency bandwidth different from the first frequency bandwidth. In some examples, the WLAN device may operate in the second frequency bandwidth for a duration (e.g., a non-occupancy period) after detecting the signal, and the WLAN device may monitor for one or more signals after the expiration of such duration. If the WLAN device does not detect a signal associated with the use of the first frequency bandwidth by the one or more cellular networks, the WLAN device may operate via the first frequency bandwidth, and the WLAN device may be configured to perform periodic monitoring for signals from cellular devices while operating in the first frequency bandwidth.

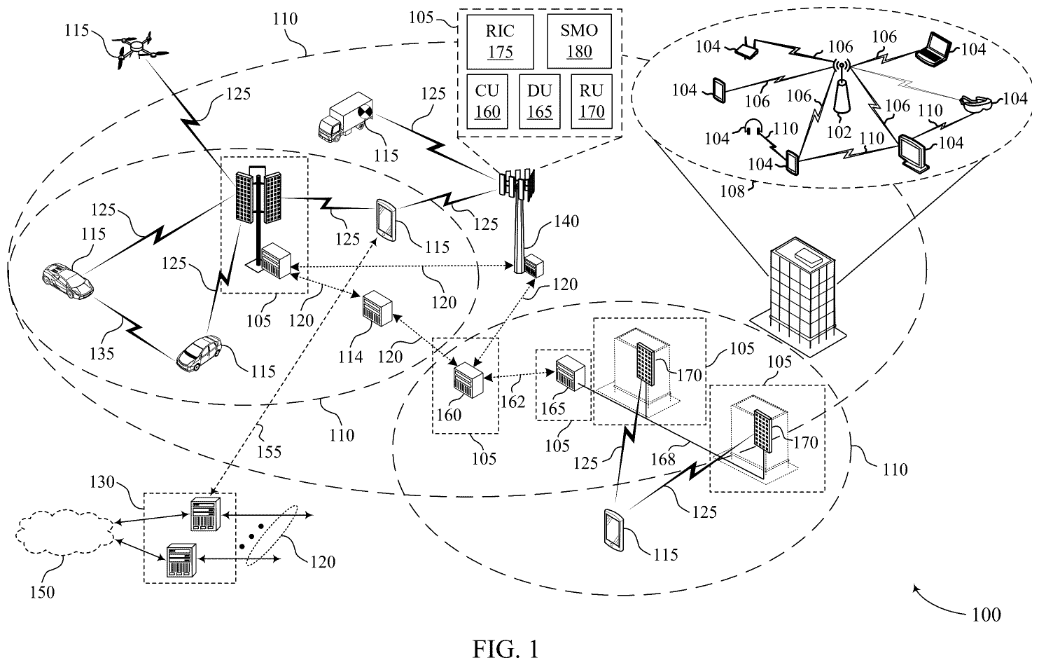

FIG. 1 shows an example of a wireless communications system 100 that supports dynamic frequency selection for cellular and Wi-Fi spectrum sharing. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 112 (e.g., a geographic coverage area) over which the UEs 115 and the network entity 105 may establish the communication link(s) 125. The coverage area 112 may be an example of a geographic area over which a network entity 105 and a UE 115 may support the communication of signals according to one or more radio access technologies (RATs).

The UEs 115 may be dispersed throughout a coverage area 112 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 114) may be partially controlled by each other. The IAB node(s) 114 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 114) via supported access and backhaul links (e.g., backhaul communication link(s) 120). IAB node(s) 114 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 114 used for access via the DU 165 of the IAB node(s) 114 (e.g., referred to as virtual IAB-MT (vIAB-MT)). In some examples, the IAB node(s) 114 may include one or more DUs (e.g., DUs 165) that support communication links with additional entities (e.g., IAB node(s) 114, UEs 115) within the relay chain or configuration of the access network (e.g., downstream). In such cases, one or more components of the disaggregated RAN architecture (e.g., the IAB node(s) 114 or components of the IAB node(s) 114) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ns may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 112. In some examples, coverage areas 112 (e.g., different coverage areas) associated with different technologies may overlap, but the coverage areas 112 (e.g., different coverage areas) may be supported by the same network entity (e.g., a network entity 105). In some other examples, overlapping coverage areas, such as a coverage area 112, associated with different technologies may be supported by different network entities (e.g., the network entities 105). The wireless communications system 100 may include, for example, a heterogeneous network in which different types of the network entities 105 support communications for coverage areas 112 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 112 of a network entity 105 (e.g., a base station 140, an RU 170), which may support aspects of such D2D communications being configured by (e.g., scheduled by) the network entity 105. In some examples, one or more UEs 115 of such a group may be outside the coverage area 112 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

According to some aspects, the wireless communications system 100 may incorporate a WLAN system 108, which can be an example of a Wi-Fi network. For example, the WLAN system 108 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the WLAN system 108 can be an example of a cellular radio access network (RAN), such as a 5G or 6G RAN that implements one or more cellular protocols such as those specified in one or more 3GPP standards. In some other examples, the WLAN system 108 can include a WLAN that functions in an interoperable or converged manner with one or more cellular RANs to provide greater or enhanced network coverage to wireless communication devices within the WLAN system 108 or to enable such devices to connect to a cellular network's core, such as to access the network management capabilities and functionality offered by the cellular network core. In some other examples, the WLAN system 108 can include a WLAN that functions in an interoperable or converged manner with one or more personal area networks, such as a network implementing Bluetooth or other wireless technologies, to provide greater or enhanced network coverage or to provide or enable other capabilities, functionality, applications, or services.

The WLAN system 108 may include numerous wireless communication devices including an AP 102 and any number of STAs 104. While only one AP 102 is shown in FIG. 1, the WLAN system 108 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a UE 115, a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. The WLAN system 108 may encompass a coverage area of the AP 102, which may represent a basic service area (BSA) of the WLAN system 108. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the WLAN system 108 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the WLAN system 108 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the WLAN system 108. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN system 108 may transmit PPDUs over an unlicensed spectrum, which may be a portion of spectrum that includes frequency bands traditionally used by Wi-Fi technology, such as the 2.4 GHZ, 5 GHZ, 6 GHz, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHz), FR4a or FR4-1 (52.6 GHZ-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining, or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

The AP 102 and the STAs 104 of the WLAN system 108 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while an UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHZ.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the WLAN system 108 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some systems, various wireless devices of the wireless communications system 100 may use different portions of a frequency spectrum. For example, cellular devices (e.g., devices operating according to 3GPP-based procedures, such as UEs 115 and network entities 105) and WLAN devices (e.g., APs 102 and STAs 104) may operate using different portions of the frequency spectrum, which may avoid interference between these devices. In some examples, however, portions of the frequency spectrum may be shared between devices operating using different communication procedures. For example, some portions of the frequency spectrum may be used by both WLAN devices and cellular devices.

In accordance with examples as described herein, wireless devices, such as WLAN devices, may operate in a shared frequency bandwidth based on monitoring for one or more signals from cellular devices. For example, a WLAN device (e.g., an AP 102 or a STA 104) may detect a broadcast signal (e.g., an SSB) or a beacon signal (e.g., an IEEE beacon signal) via a first frequency bandwidth, and determine that the first frequency bandwidth is in use by one or more devices of a cellular network (e.g., one or more UEs 115 and/or network entities 105). As such, the WLAN device may perform communication operations (e.g., WLAN operations) via a second frequency bandwidth different from the first frequency bandwidth. In some examples, the WLAN device may operate in the second frequency bandwidth for a duration (e.g., a non-occupancy period) after detecting the signal, and the WLAN device may monitor for one or more signals after the expiration of such duration. If the WLAN device does not detect a signal associated with the use of the first frequency bandwidth by the one or more cellular networks, the WLAN device may operate via the first frequency bandwidth, and the WLAN device may be configured to perform periodic monitoring for signals from cellular devices while operating in the first frequency bandwidth.

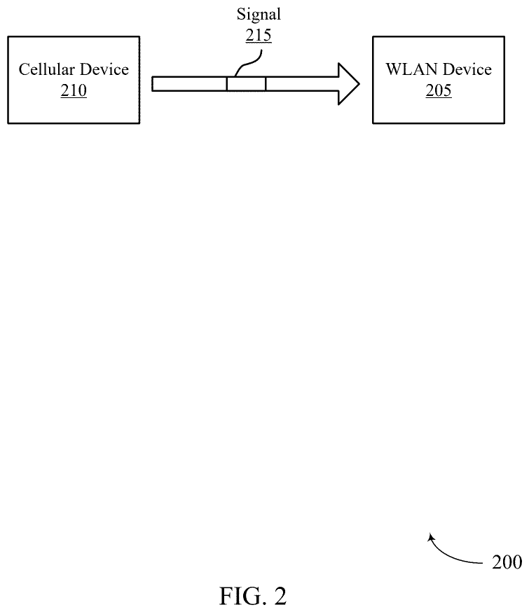

FIG. 2 shows an example of a system 200 that supports dynamic frequency selection for cellular and Wi-Fi spectrum sharing. The system 200 illustrates a WLAN device 205, which may be an example of an AP 102 or a STA 104, and a cellular device 210, which may be an example of a network entity 105 or a UE 115, as described herein.

In some systems, various wireless devices may use different portions of a frequency spectrum. For example, cellular devices 210 (e.g., devices operating according to 3GPP-based procedures, international mobile telecommunications (IMT) devices, or devices operating within a mobile/fixed communications network (MFCN)) and WLAN devices 205 may operate using different portions of the frequency spectrum, which may avoid interference between these devices. In some examples, however, portions of the frequency spectrum may be shared between devices operating using different communication procedures. For example, some portions of the frequency spectrum may be used by both WLAN devices 205 and cellular devices 210.

In accordance with examples as described herein, a WLAN device 205 may operate in a shared frequency bandwidth with cellular devices 210 based on monitoring for one or more signals 215 from cellular devices 210. For example, the WLAN device 205 may determine to initiate communications (e.g., WLAN communications, such as with other WLAN devices 205) in a first frequency bandwidth. The first frequency bandwidth may be a shared frequency bandwidth with cellular devices 210 (e.g., a 6 GHz bandwidth, a 6.425 GHz to 7.125 GHz bandwidth, or another bandwidth). As such, prior to performing communications on the first frequency bandwidth, the WLAN device 205 may monitor the first frequency bandwidth for one or more signals 215 associated with the use of the first frequency bandwidth by one or more cellular networks (e.g., by one or more cellular devices 210). In some cases, these techniques may apply to some WLAN devices 205 (e.g., APs 102) but not others (e.g., STAs 104).

In some examples, the WLAN device 205 may monitor for the one or more signals associated with the use of the first frequency bandwidth by one or more cellular networks for a first duration (e.g., configured duration, a channel availability check time). If the WLAN device 205 does not detect a signal during the first duration, the WLAN device 205 may perform communications (e.g., WLAN operations, transmissions) via the first frequency bandwidth. Alternatively, if the WLAN device 205 does detect a signal associated with the use of the first frequency bandwidth by one or more cellular networks, the WLAN device 205 may refrain from performing communications via the first frequency bandwidth, and may perform communications via a second frequency bandwidth (e.g., or a different channel of the first frequency bandwidth).

In some examples, the one or more signals associated the use of the first frequency bandwidth by one or more cellular networks may include a broadcast signal 215 (e.g., a signal in accordance with 3GPP procedures). For example, the cellular device 210 may broadcast a broadcast signal 215 (e.g., an SSB) to one or more other cellular devices 210. The WLAN device 205 may detect the broadcast signal 215 during the first duration for the monitoring (e.g., the channel availability check time), which may indicate to the WLAN device 205 that the first frequency bandwidth is in use by one or more cellular networks. In some cases, the WLAN device 205 may be configured to decode the broadcast signal 215 (e.g., in accordance with 3GPP techniques), such as to determine that the first frequency bandwidth is in use by one or more cellular networks. Additionally, or alternatively, a portion of the broadcast signal 215 (e.g., a field, a prefix) may be configured to be decodable by WLAN devices 205, and the WLAN device 205 may detect the use of the first frequency bandwidth based on the portion of the broadcast signal 215. In some examples, the portion of the broadcast signal 215 may include an indication of the use of the first frequency bandwidth by the cellular device 210, and may indicate one or more parameters to the WLAN device 205 (e.g., associated with a raster location, or another parameter).

Additionally, or alternatively, the one or more signals associated the use of the first frequency bandwidth by one or more cellular networks may include a beacon signal 215 (e.g., in accordance with IEEE procedures, such as IEEE 802.11, an IEEE broadcast signal). In some examples, the beacon signal 215 may include a preamble (e.g., a WLAN preamble, a Wi-Fi preamble) which may indicate the WLAN device 205 of the use of the first frequency bandwidth by the one or more cellular networks. Additionally, or alternatively, the beacon signal 215 may include a receiver address which may indicate the use of the first frequency bandwidth by the one or more cellular networks.

In some examples, the one or more signals associated the use of the first frequency bandwidth by one or more cellular networks may include a signal 215 (e.g., a cross-technology signal) may have a specific waveform that indicates the use of the first frequency bandwidth (e.g., a waveform that is particular to indicating the use of the first frequency bandwidth by one or more cellular networks, rather than a signal having additional use within a cellular (e.g., 3GPP-compliant) or WLAN (e.g., IEEE 802.11-compliant) network. For example, the cellular device 210 may transmit the signal 215 with a waveform (e.g., a specific or configured waveform) that may indicate nearby WLAN devices 205 that the first frequency bandwidth is in use by one or more cellular networks (e.g., by the cellular device 205 in communications with a cellular network). In some examples, the signal 215 may indicate whether the device transmitting the signal (e.g., the cellular device 210) is a network entity 105 or a UE 115. Additionally, or alternatively, the one or more signals associated the use of the first frequency bandwidth by one or more cellular networks may include a signal 215 having a waveform that is used by one or more cellular signals (e.g., a 3GPP waveform) or WLAN signals (e.g., an IEEE 802.11 waveform).

In some cases, the WLAN device 205 may determine whether a signal is associated with the first frequency bandwidth being in use by one or more cellular network based on a power associated with a detected signal 215. For example, the WLAN device 205 may be configured with a threshold value (e.g., a power threshold, a detection threshold). The WLAN device 205 may refrain from performing communications via the first frequency bandwidth (e.g., for a non-occupancy period) if the WLAN device 205 detects a signal associated with the use of the first frequency bandwidth by one or more cellular networks having a power value (e.g., a received power value) satisfying (e.g., meeting and/or exceeding) the threshold value. Alternatively, in some cases, even if the WLAN device 205 detects a signal 215, the WLAN device 205 may perform communications in the first frequency bandwidth if the signal 215 does not satisfy the threshold value. In some examples, the threshold value may be modified by the WLAN device 205 during operation, such as based on a time of day or a current date (e.g., a time of the year, month, or week), or based on a quantity of other devices detected near the WLAN device 205. Additionally, or alternatively, the threshold value may be modified by another devices (e.g., an authorization server), which may transmit a message to the WLAN device 205 indicating for the modification of the threshold value.

In some examples, the transmit power of a signal that supports detection by the WLAN device 205 of the use of the first frequency bandwidth by one or more cellular networks, the threshold value used to detect such a signal (e.g., to detect the detected signal 215), or both may be set a same, equal, or lower power compared to the transmit power or detection threshold for a control channel used by the WLAN device 205. Additionally, or alternatively, the transmit power of a signal associated with the use of the first frequency bandwidth by one or more cellular networks, the threshold value used to detect such a signal (e.g., to detect the detected signal 215), or both may be set a same, equal, or lower power compared to the transmit power or detection threshold for a data channel used by the WLAN device 205. The transmit power of a signal associated with the use of the first frequency bandwidth by one or more cellular networks, the threshold value used to detect such a signal (e.g., to detect the detected signal 215), or both may be configured statically (e.g., by a standard), semi-statically (e.g., indicated to the cellular device 210 or the WLAN device 205 as part of control or configuration signaling and applicable for a medium or long-term duration, such as being indicated following establishment of a connection or communication session and applicable until a subsequent disconnection or end of the communication session), or dynamically (e.g., indicated to the cellular device 210 or the WLAN device 205 via control signaling and applicable for a short-term duration, such as being indicated following establishment of a connection or communication session and subject to updating during a same communication session or prior to a subsequent disconnection). Increasing the transmit power of the signal associated with the use of the first frequency bandwidth by one or more cellular networks, the threshold value used to detect such a signal, or both may enlarge the geographic area in which the WLAN device 205 will detect the signal, while decreasing the transmit power of the signal associated with the use of the first frequency bandwidth by one or more cellular networks, the threshold value used to detect such a signal, or both may shrink the geographic area in which the WLAN device 205 will detect the signal.

A signal that supports detection by the WLAN device 205 of the use of the first frequency bandwidth by one or more cellular networks may be transmitted by the cellular device 210 using beamforming techniques (e.g., using an active antenna system (AAS). In such examples, the signal may be transmitted (e.g., broadcast) in all directions (e.g., to cover a 360 degree area around the cellular device 210) or only in one or more specific directions (e.g., one or more directions associated with active or planned communications by the cellular device 210, such as one or more directions associated with one or more UEs 115 served by or otherwise in communication with the cellular device 210). Transmitting the signal in all directions may reduce complexity, while transmitting the signal in only one or more specific directions may reduce an area of impact (e.g., an area of detection) for the WLAN device 205. Whether to transmit the signal in all directions, whether to transmit the signal only in one or more specific directions, the one or more specific directions or any combination thereof may be configured at the cellular device 210 statically, semi-statically, or dynamically.

In some examples, the WLAN device 205 may determine whether the first frequency bandwidth is in use by one or more cellular networks based on a periodicity of detected signals 215. For example, the WLAN device 205 may determine that signals 215 are being transmitted based on observed power values on the first frequency bandwidth, which may indicate transmission of cellular signals 215 from one or more cellular devices 210. In some examples, a periodicity of detected transmissions via the first frequency bandwidth (e.g., based on energy spikes of detected power) may indicate the WLAN device 205 that the first frequency bandwidth is in use by one or more cellular networks. As such, the WLAN device 205 may detect the use of the first frequency bandwidth by one or more cellular networks without being configured to decode the one or more signals 215 (e.g., or based on the one or more signals 215 not being decodable by the WLAN device 205).

In some cases, the WLAN device 205 may determine to refrain from performing operations via the first frequency bandwidth based on detecting a threshold quantity of cellular devices 210 (e.g., cellular nodes) operating via the first frequency bandwidth. In some examples, the quantity of cellular devices 205 may be configured as a value of one, or a higher value. In some cases, the threshold quantity of cellular devices 210 may be modified (e.g., at least temporarily) by the WLAN device 205 or by another entity (e.g., through a server associated with the WLAN device 205). Additionally, or alternatively, the WLAN device 205 may be configured with different threshold quantities based on different cellular devices 210 (e.g., a threshold quantity for UEs 115 and a threshold quantity for network entities 105).

In some examples, after initiating communications via the first frequency bandwidth (e.g., based on not detecting a signal associated with the use of the first frequency bandwidth by one or more cellular networks), the WLAN device 205 may periodically monitor the first frequency bandwidth. For example, the WLAN device 205 may monitor the first frequency bandwidth again after a duration has elapsed (e.g., an in-service monitoring duration) since the last monitoring, or since beginning to operate in the first frequency bandwidth. The WLAN device 205 may determine whether to continue operating (e.g., performing communications) in the first frequency bandwidth based on whether a signal 215 associated with the use of the first frequency bandwidth by one or more cellular networks is detected. For example, if such a signal 215 is not detected, the WLAN device 205 may continue operating in the first frequency bandwidth. Alternatively, if such a signal 215 is detected, the WLAN device 205 may stop operating in the first frequency bandwidth (e.g., or in a current channel of the first frequency bandwidth).

In some cases, if the WLAN device 205 determines to stop operating in the first frequency bandwidth after detection of a signal 215, the WLAN device 205 may be configured with a duration (e.g., a channel closing transmission time, a time for closing a transmission) for closing transmissions in the first frequency bandwidth (e.g., or a channel thereof). Additionally, or alternatively, the WLAN device 205 may be configured with a duration (e.g., a channel move time) for ceasing to operate in the first frequency bandwidth (e.g., or a channel thereof). For example, after detecting the signal 215 associated with the use of the first frequency bandwidth by one or more cellular networks, the WLAN device 205 may continue performing communications via the first frequency bandwidth (e.g., or a channel thereof) for at most the duration (e.g., the channel closing transmission time) before switching to another frequency bandwidth (e.g., or another channel of the first frequency bandwidth). In some cases, the WLAN device 205 may close existing transmissions over this duration, such as by communicating with one or more other WLAN devices 205.

Accordingly, the WLAN device 205 may operate in the first frequency bandwidth based on monitoring of the first frequency bandwidth for one or more signals 215 associated with the use of the first frequency bandwidth by one or more cellular devices 210.

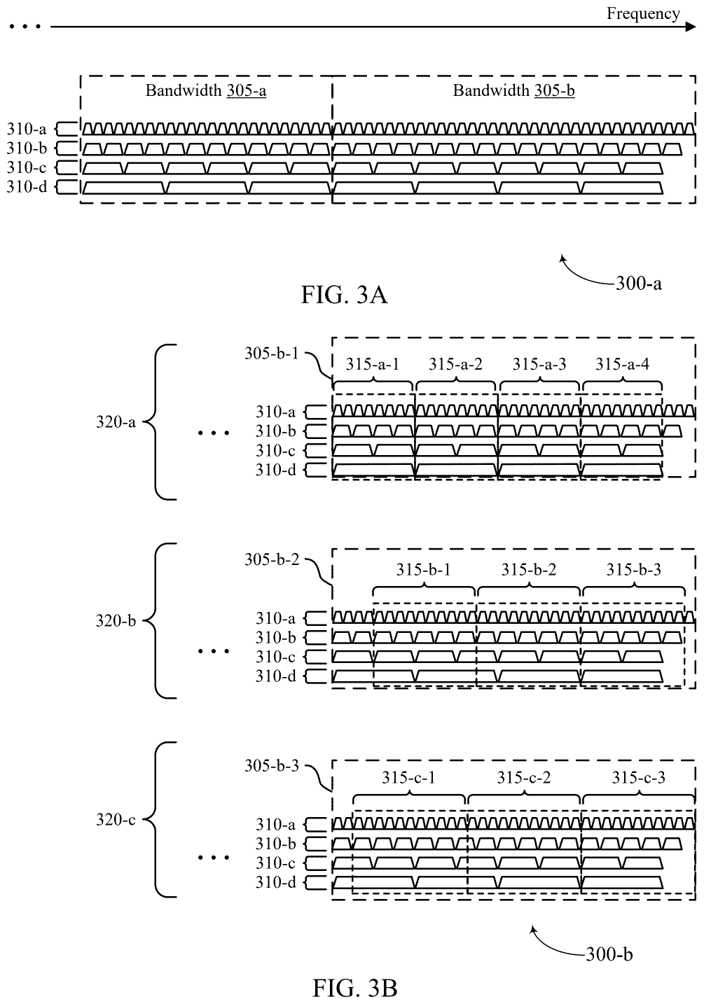

FIG. 3A and FIG. 3B shows examples of a frequency diagram 300-a and a frequency diagram 300-b, respectively, that support dynamic frequency selection for cellular and Wi-Fi spectrum sharing. Aspects of the frequency diagram 300-a and the frequency diagram 300-b may be implemented by a WLAN device 205 (e.g., an AP 102, a STA 104), and a cellular device 210 (e.g., a UE 115, a network entity 105), as described herein.

The frequency diagram 300-a may illustrate a division of the frequency spectrum. For example, a bandwidth 305-a may correspond to a range of frequencies that may be used by WLAN devices 205 for communications with other WLAN devices 205. A bandwidth 305-b may correspond to a range of frequencies (e.g., a 6 GHz bandwidth, a range between 6.425 GHz and 7.125 GHZ, or another range) that may be shared between WLAN devices 205 and cellular devices 210.

In some examples, the bandwidth 305-a and the bandwidth 305-b may include a set of channels 310-a (e.g., 20 MHz channels), a set of channels 310-b (e.g., 40 MHz channels), a set of channels 310-c (e.g., 80 MHz channels), and a set of channels 310-d (e.g., 160 MHz channels), which may be used by a WLAN device 205 for communications (e.g., with other WLAN devices 205). In some cases, if the WLAN device 205 determines to operate in the bandwidth 305-b as described herein, the WLAN device 205 may randomly select a channel 310, which may support uniform spreading on the bandwidth 305-b between devices. For example, the WLAN device 205 may select a channel type (e.g., between channels 310-a, channels 310-b, channels 310-c, and channels 310-d) for communications, and then randomly select a channel 310 from the selected channel type.

In some examples, if the WLAN device 205 determines that the bandwidth 305-b is in use by one or more cellular networks (e.g., based on detection of signals as described herein), the WLAN device 205 may operate in the bandwidth 305-b using a channel 310 different from a channel associated with a detected signal. For example, the WLAN device 205 may determine that the detected signal is transmitted via a first channel 310, and the WLAN device 205 may select a different (e.g., non-overlapping in frequency) channel 310 for communications. In some other examples, the detect signal may (e.g., explicitly) include an indication of a channel 310, a frequency range, or both, and the WLAN device 205 may select a channel 310 that does not overlap in frequency with the indicated channel 310 or frequency range. Additionally, or alternatively, the WLAN device 205 may apply a separation distance (e.g., in units of frequency, such as MHz, or in units of channels 310) from a channel 310 associated with a detected signal, and may select a channel 310 for communications based on the separation distance from the channel 310 associated with the detected signal.

Alternatively, the WLAN device 205 may perform communications via the bandwidth 305-a based on detection of a signal associated with the use of the bandwidth 305-b by one or more cellular networks. In some cases, whether the WLAN device 205 operates in a different bandwidth (e.g., the bandwidth 305-a) or a different channel 310 based on detection of one or more signals via monitoring the bandwidth 305-b may change over time, for example, based on conditions such as a current time of day, a current date (e.g., a time of year, month, or week), or a quantity of other devices (e.g., WLAN devices 205, cellular devices 210, or both) that are near (e.g., or predicted to be near, such as by artificial intelligence procedures) the WLAN device 205. For example, a large quantity of cellular devices 210 (e.g., devices operating using cellular techniques, such as 3GPP-based technologies) near (e.g., or predicted to be near) the WLAN device 205 may indicate the WLAN device 205 to refrain from operating in any channel of the bandwidth 305-b after detection of a signal indicating use of the bandwidth 305-b by one or more cellular networks. In some cases, at least one of such conditions may be indicated by another devise (e.g., an authorization server).

The frequency diagram 300-b illustrates separation of the bandwidth 305-b into multiple ranges for mobile network operators 315 (e.g., each mobile network operator 315 corresponding to one or more carriers or operators for cellular networks). In some examples, the bandwidth 305-b may be divided by mobile network operators 315 in a manner that aligns with channels 310, which may increase the efficiency and channel utilization of channels 310 by WLAN devices 305.

For example, if a WLAN device 305 detects one or more signals associated with the use of the bandwidth 305-b corresponding to a mobile network operator 315, the WLAN device 305 may perform communications via portions of the frequency bandwidth 305-b that do not correspond to the mobile network operator 315. By aligning the portions of the bandwidth 305-b corresponding to each mobile network operator 315, the availability of channels 310 for the WLAN device 305 to select for communications may be increased.

In case 320-a, a bandwidth 305-b-1 may be divided into frequency ranges corresponding to a mobile network operator 315-a-1, a mobile network operator 315-a-2, a mobile network operator 315-a-3, and a mobile network operator 315-a-4. In the case 320-a, the frequency ranges may be aligned with channels 310-d (e.g., the 160 MHz channels), which may also result in the frequency ranges being aligned with the channels 310-a, the channels 310-b, and the channels 310-c. As such, the case 320-a may support a high level of channel utilization for WLAN devices 205.

In case 320-b, a bandwidth 305-b-2 may be divided into frequency ranges corresponding to a mobile network operator 315-b-1, a mobile network operator 315-b-2, and a mobile network operator 315-b-3. In the case 320-b, the frequency ranges may be aligned with channels 310-b (e.g., the 40 MHz channels), which may also result in the frequency ranges being aligned with the channels 310-a. As such, this may support increased channel utilization for WLAN devices 205 for channels 310-a and channels 310-b. In the case 320-b, the frequency ranges for each mobile network operator 315-b may be 200 MHz.

In case 320-c, a bandwidth 305-b-3 may be divided into frequency ranges corresponding to a mobile network operator 315-c-1, a mobile network operator 315-c-2, and a mobile network operator 315-c-3. In the case 320-c, the frequency ranges may be aligned with channels 310-a (e.g., the 20 MHz channels). As such, this may support increased channel utilization for WLAN devices 205 for channels 310-a. In the case 320-c, the frequency ranges for each mobile network operator 315-c may be 220 MHz, resulting in higher frequency utilizations per mobile network operator 315.

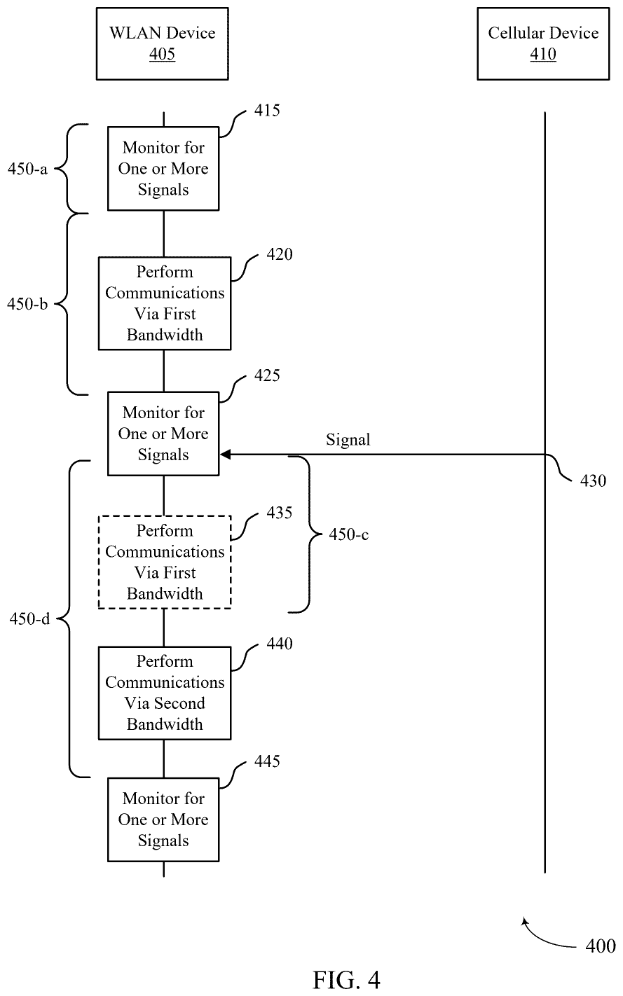

FIG. 4 shows an example of a process flow 400 that supports dynamic frequency selection for cellular and Wi-Fi spectrum sharing. The process flow 400 illustrates communications between a WLAN device 405 (e.g., a WLAN device 205, an AP 102, a STA 104) and a cellular device 410 (e.g., a cellular device 210, a UE 115, a network entity 105). In some cases, steps shown in the process flow 400 may be omitted or be performed in a different order than shown. Additionally, or alternatively, steps not shown may be added to the process flow 400.

At 415, the WLAN device 405 may monitor a first frequency bandwidth for one or more signals associated with use of the first frequency bandwidth by one or more cellular networks. In some examples, the first frequency bandwidth may be shared between WLAN devices 405 and cellular devices 410. The WLAN device 405 may perform the monitoring for at least a duration 450-a (e.g., a channel availability check time).

At 420, the WLAN device 405 may perform communications via the first frequency bandwidth based on an absence of one or more signals associated with use of the first frequency bandwidth by one or more cellular networks being detected during the duration 450-a.

At 425, the WLAN device 405 may monitor the first frequency bandwidth for one or more additional signals associated with use of the first frequency bandwidth by one or more cellular networks. In some examples, the monitoring may be triggered based on a duration 450-b (e.g., an in-service monitoring time) elapsing since the monitoring at 415 (e.g., the beginning of the monitoring, the end of the monitoring). Additionally, or alternatively, the duration 450-b may be measured from start of the communications at 420. As such, the WLAN device 405 may periodically monitor the first frequency bandwidth while operating via the first frequency bandwidth.

In some cases, at 430, the cellular device 410 may transmit (e.g., output, broadcast) a signal (e.g., a broadcast signal, a beacon signal, a cellular signal, or another signal) associated with use of the first frequency bandwidth by one or more cellular networks. The WLAN device 405 may detect the signal during the monitoring of the first frequency bandwidth.

In some cases, at 435, the WLAN device 405 may continue performing the communications via the first frequency bandwidth after detecting the signal. For example, the WLAN device 405 may preform communications via the first frequency bandwidth for at most a duration 450-c (e.g., a channel closing transmission time, a channel move time, after detection of the signal), which may allow the WLAN device 405 to close existing communications via the first frequency bandwidth (e.g., and redirect the communications to a second bandwidth or a different channel of the first frequency bandwidth).

After detecting the signal, the WLAN device 405 may be configured to refrain from performing communications via the first frequency bandwidth (e.g., or via a channel of the first frequency bandwidth, or via a subset of the first frequency bandwidth corresponding to a mobile network operator) for a duration 450-d (e.g., a non-occupancy period).

At 445, the WLAN device 405 may monitor the first frequency bandwidth for one or more additional signals associated with use of the first frequency bandwidth by one or more cellular networks based on the duration 450-d having elapsed. As such, the WLAN device 405 may operate in the first frequency bandwidth based on the monitoring of the first frequency bandwidth.

In some examples, one or more of the durations 450 (e.g., the duration 450-a, the duration 450-b, the duration 450-c, and the duration 450-d) may be modified during operation of the WLAN device 405. For example, one or more of the durations 450 may be semi-static, and may be modified (e.g., in a medium or long-term scale) based on one or more conditions being met. For instance, one or more of the durations 450 may be modified (e.g., updated) by the WLAN device 405 based on a time of day or a current date (e.g., a time of the year, month, or week), or based on a quantity of other devices detected near the WLAN device 405 (e.g., WLAN devices 405, cellular devices 410, or both). Additionally, or alternatively, the threshold value may be modified by another device (e.g., an authorization server), which may transmit a message to the WLAN device 205 indicating one or more updated values for the durations 445. In some other examples, the WLAN device 405 may receive information (e.g., from another device) that may indicate the WLAN device 405 to modify the one or more durations, such the occurrence of an event (e.g., a concert or sporting event) that may be associated with a high quantity of devices near the WLAN device 405. In some examples, a message indicating one or more values (e.g., one or more updated values) for the durations 445 may be transmitted by the cellular device 410 (e.g., as part of a signal used to detect the use of the first frequency bandwidth by one or more cellular networks, such as the signal received at 430), or by another device included in a same cellular network as the cellular device 410.

In some cases, one or more of the durations 450 may be modified dynamically (e.g., on a short-term scale). For example, the WLAN device 405 may estimate a quantity of devices (e.g., cellular devices 410, WLAN devices 405, or both) in an area (e.g., near the WLAN device 405). For example, the WLAN device 405 may use artificial intelligence (e.g., machine learning) procedures to estimate the quantity of devices, for example, based on data collected by the WLAN device 405. As such, one or more of the durations 450 may be updated to be longer or shorter based on the quantity of users (e.g., detected or predicted) near the WLAN device 405.

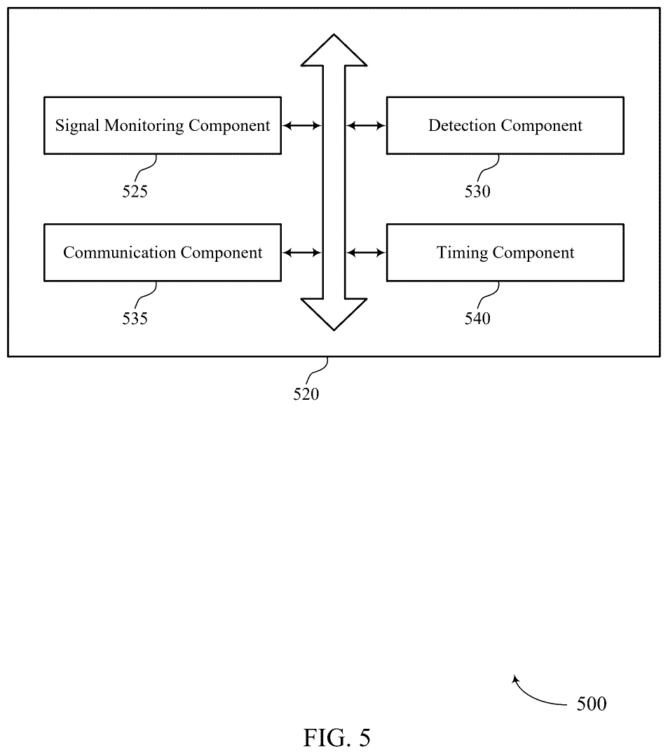

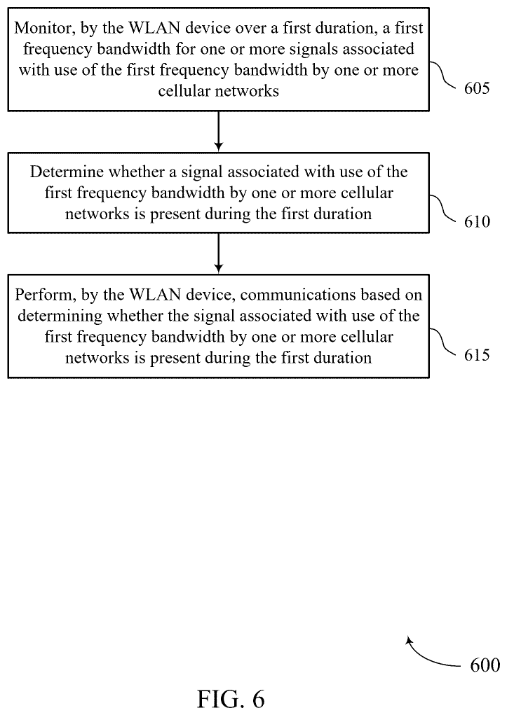

FIG. 5 shows a block diagram of an example wireless communication device 500 that supports dynamic frequency selection for cellular and Wi-Fi spectrum sharing. In some examples, the wireless communication device 500 is configured to perform the process 600 described with reference to FIG. 6. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in an AP or STA, such as the AP 102 or the STA 104 described with reference to FIG. 1. In some other examples, the wireless communication device 500 can be an AP or STA that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes a user interface (UI) (such as a touchscreen or keypad) and a display, which may be integrated with the UI to form a touchscreen display that is coupled with the processing system. In some examples, the wireless communication device 500 may further include one or more sensors such as, for example, one or more inertial sensors, accelerometers, temperature sensors, pressure sensors, or altitude sensors, which may be coupled with the processing system. In some examples, the wireless communication device 500 further includes at least one external network interface coupled with the processing system that enables communication with a core network or backhaul network that enables the wireless communication device 500 to gain access to external networks including the Internet.

The wireless communication device 500 includes a signal monitoring component 525, a detection component 530, a communication component 535, and a timing component 540. Portions of one or more of the signal monitoring component 525, the detection component 530, the communication component 535, and the timing component 540 may be implemented at least in part in hardware or firmware. For example, one or more of the signal monitoring component 525, the detection component 530, the communication component 535, and the timing component 540 may be implemented at least in part by at least a processor or a modem. In some examples, portions of one or more of the signal monitoring component 525, the detection component 530, the communication component 535, and the timing component 540 may be implemented at least in part by a processor and software in the form of processor-executable code stored in memory.

The signal monitoring component 525 is configurable or configured to monitor, by the WLAN device over a first duration, a first frequency bandwidth for one or more signals associated with use of the first frequency bandwidth by one or more cellular networks. The detection component 530 is configurable or configured to determine whether a signal associated with use of the first frequency bandwidth by one or more cellular networks is present during the first duration. The communication component 535 is configurable or configured to perform, by the WLAN device, communications based on determining whether the signal associated with use of the first frequency bandwidth by one or more cellular networks is present during the first duration.

In some examples, the communication component 535 is configurable or configured to perform the communications via the first frequency bandwidth based on an absence during the first duration of the signal associated with use of the first frequency bandwidth by one or more cellular networks.

In some examples, the signal monitoring component 525 is configurable or configured to monitor, by the WLAN device after a second duration has elapsed, for one or more additional signals associated with use of the first frequency bandwidth by one or more cellular networks. In some examples, the detection component 530 is configurable or configured to determine whether to continue performing the communications via the first frequency bandwidth based on whether an additional signal associated with use of the first frequency bandwidth by one or more cellular networks is present.

In some examples, the communication component 535 is configurable or configured to perform, by the WLAN device for at least a third duration, the communications via a second frequency bandwidth different from the first frequency bandwidth based on a presence during the first duration of the signal associated with use of the first frequency bandwidth by one or more cellular networks.

In some examples, the signal monitoring component 525 is configurable or configured to monitor, by the WLAN device after the third duration has elapsed, the first frequency bandwidth for another one or more signals associated with use of the first frequency bandwidth by one or more cellular networks. In some examples, performing the communications via the second frequency bandwidth is based on the signal associated with use of the first frequency bandwidth by one or more cellular networks having a received power that satisfies a threshold value.

In some examples, the detection component 530 is configurable or configured to detect a periodicity between at least two signals associated with use of the first frequency bandwidth by one or more cellular networks, where performing the communications is based on whether the periodicity between the at least two signals indicates use of the first frequency bandwidth by one or more cellular networks.

In some examples, the communication component 535 is configurable or configured to perform, by the WLAN device, the communications via the first frequency bandwidth for at most a fourth duration based on a presence during the first duration of the signal associated with use of the first frequency bandwidth by one or more cellular networks. In some examples, the communication component 535 is configurable or configured to refrain from performing communications via the first frequency bandwidth after the fourth duration has elapsed.

In some examples, the WLAN device is configured with a set of values corresponding to the first duration associated with a duration for the monitoring, a second duration associated with a time between monitoring occasions, a third duration associated with a non-occupancy period, a fourth duration associated with a time for closing a channel transmission, or any combination thereof.

In some examples, the timing component 540 is configurable or configured to adjust the set of values based on a time of day, a current date, or both.

In some examples, the timing component 540 is configurable or configured to receive a message indicating one or more updated values corresponding to the set of values. In some examples, the timing component 540 is configurable or configured to update the set of values based on receiving the message.

In some examples, the detection component 530 is configurable or configured to detect the signal associated with use of the first frequency bandwidth by one or more cellular networks, where the signal indicates use of a first channel of the first frequency bandwidth by one or more cellular networks. In some examples, the communication component 535 is configurable or configured to perform the communications via a second channel of the first frequency bandwidth based on detecting the signal.

In some examples, the signal associated with use of the first channel of the first frequency bandwidth by one or more cellular networks indicates the use of the first channel of the first frequency bandwidth by one or more cellular networks by being transmitted over the first channel.

In some examples, the communication component 535 is configurable or configured to randomly select the second channel from among a set of channels of the first frequency bandwidth that excludes the first channel. In some examples, the signal associated with use of the first frequency bandwidth by one or more cellular networks includes a cellular broadcast signal or a beacon signal.

FIG. 6 shows a flowchart illustrating an example process 600 performable by or at a WLAN device that supports dynamic frequency selection for cellular and Wi-Fi spectrum sharing. The operations of the process 600 may be implemented by a WLAN device or its components as described herein. For example, the process 600 may be performed by a wireless communication device, such as the wireless communication device 500 described with reference to FIG. 5, operating as or within a wireless AP or a wireless STA. In some examples, the process 600 may be performed by a wireless AP or a wireless STA, such as one of the APs 102 or the STAs 104 described with reference to FIG. 1.

In some examples, in 605, the WLAN device may monitor, by the WLAN device over a first duration, a first frequency bandwidth for one or more signals associated with use of the first frequency bandwidth by one or more cellular networks. The operations of 605 may be performed in accordance with examples as disclosed herein. In some implementations, aspects of the operations of 605 may be performed by a signal monitoring component 525 as described with reference to FIG. 5.

In some examples, in 610, the WLAN device may determine whether a signal associated with use of the first frequency bandwidth by one or more cellular networks is present during the first duration. The operations of 610 may be performed in accordance with examples as disclosed herein. In some implementations, aspects of the operations of 610 may be performed by a detection component 530 as described with reference to FIG. 5.

In some examples, in 615, the WLAN device may perform, by the WLAN device, communications based on determining whether the signal associated with use of the first frequency bandwidth by one or more cellular networks is present during the first duration. The operations of 615 may be performed in accordance with examples as disclosed herein. In some implementations, aspects of the operations of 615 may be performed by a communication component 535 as described with reference to FIG. 5.

Implementation examples are described in the following numbered clauses:

Aspect 1: A method for wireless communication by a WLAN device, comprising: monitoring, over a first duration, a first frequency bandwidth for one or more signals associated with use of the first frequency bandwidth by one or more cellular networks; determining whether a signal associated with use of the first frequency bandwidth by one or more cellular networks is present during the first duration; and performing communications based at least in part on the determination of whether the signal associated with use of the first frequency bandwidth by one or more cellular networks is present during the first duration.

Aspect 2: The method of aspect 1, further comprising: performing the communications via the first frequency bandwidth based at least in part on an absence during the first duration of the signal associated with use of the first frequency bandwidth by one or more cellular networks.

Aspect 3: The method of aspect 2, further comprising: monitoring, after a second duration has elapsed, for one or more additional signals associated with use of the first frequency bandwidth by one or more cellular networks; and determining whether to continue to perform the communications via the first frequency bandwidth based at least in part on whether an additional signal associated with use of the first frequency bandwidth by one or more cellular networks is present.

Aspect 4: The method of any of aspects 1 through 3, further comprising: performing, for at least a third duration, the communications via a second frequency bandwidth different from the first frequency bandwidth based at least in part on a presence during the first duration of the signal associated with use of the first frequency bandwidth by one or more cellular networks.

Aspect 5: The method of aspect 4, further comprising: monitoring, after the third duration has elapsed, the first frequency bandwidth for another one or more signals associated with use of the first frequency bandwidth by one or more cellular networks.

Aspect 6: The method of any of aspects 4 through 5, further comprising: performing the communications via the second frequency bandwidth based at least in part on the signal associated with use of the first frequency bandwidth by one or more cellular networks having a received power that satisfies a threshold value.

Aspect 7: The method of any of aspects 1 through 6, further comprising: detecting a periodicity between at least two signals associated with use of the first frequency bandwidth by one or more cellular networks, wherein performing the communications is based at least in part on whether the periodicity between the at least two signals indicates use of the first frequency bandwidth by one or more cellular networks.

Aspect 8: The method of any of aspects 1 through 7, further comprising: performing the communications via the first frequency bandwidth for at most a fourth duration based at least in part on a presence during the first duration of the signal associated with use of the first frequency bandwidth by one or more cellular networks; and refraining from performing communications via the first frequency bandwidth after the fourth duration has elapsed.

Aspect 9: The method of any of aspects 1 through 8, wherein the WLAN device is configured with a set of values corresponding to the first duration associated with a duration for the monitoring, a second duration associated with a time between monitoring occasions, a third duration associated with a non-occupancy period, a fourth duration associated with a time for closing a channel transmission, or any combination thereof.

Aspect 10: The method of aspect 9, further comprising: adjusting the set of values based at least in part on a time of day, a current date, or both.

Aspect 11: The method of aspect 9, further comprising: receiving a message indicating one or more updated values corresponding to the set of values; and updating the set of values based at least in part on reception of the message.

Aspect 12: The method of any of aspects 1 through 9, further comprising: detecting the signal associated with use of the first frequency bandwidth by one or more cellular networks, wherein the signal indicates use of a first channel of the first frequency bandwidth by one or more cellular networks; and performing the communications via a second channel of the first frequency bandwidth based at least in part on detection of the signal.

Aspect 13: The method of aspect 12, wherein the signal associated with use of the first channel of the first frequency bandwidth by one or more cellular networks indicates the use of the first channel of the first frequency bandwidth by one or more cellular networks by being transmitted over the first channel.

Aspect 14: The method of any of aspects 12 through 13, further comprising: randomly selecting the second channel from among a set of channels of the first frequency bandwidth that excludes the first channel.

Aspect 15: The method of any of aspects 1 through 14, wherein the signal associated with use of the first frequency bandwidth by one or more cellular networks comprises a cellular broadcast signal or a beacon signal.

Aspect 16: A WLAN device, comprising: one or more memories storing processor-executable code; and one or more processors coupled with the one or more memories and individually or collectively operable to execute the code to cause the WLAN device to perform a method of any of aspects 1 through 15.

Aspect 17: A WLAN device, comprising: at least one means for performing a method of any of aspects 1 through 15.

Aspect 18: A non-transitory computer-readable medium storing code for wireless communication by a WLAN device, the code comprising instructions executable by one or more processors to perform a method of any of aspects 1 through 15.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless local area network (WLAN) device, comprising:
one or more memories storing processor-executable code; and
one or more processors coupled with the one or more memories and individually or collectively operable to execute the code to cause the WLAN device to:
monitor, over a first duration, a first frequency bandwidth for one or more signals associated with use of the first frequency bandwidth by one or more cellular networks;
determine whether a signal associated with use of the first frequency bandwidth by one or more cellular networks is present during the first duration; and
perform communications based at least in part on the determination of whether the signal associated with use of the first frequency bandwidth by one or more cellular networks is present during the first duration.

2. The WLAN device of claim 1, wherein the one or more processors are individually or collectively further operable to execute the code to cause the WLAN device to:
perform the communications via the first frequency bandwidth based at least in part on an absence during the first duration of the signal associated with use of the first frequency bandwidth by one or more cellular networks.

3. The WLAN device of claim 2, wherein the one or more processors are individually or collectively further operable to execute the code to cause the WLAN device to:
monitor, after a second duration has elapsed, for one or more additional signals associated with use of the first frequency bandwidth by one or more cellular networks; and
determine whether to continue to perform the communications via the first frequency bandwidth based at least in part on whether an additional signal associated with use of the first frequency bandwidth by one or more cellular networks is present.

4. The WLAN device of claim 1, wherein the one or more processors are individually or collectively further operable to execute the code to cause the WLAN device to:
perform, for at least a third duration, the communications via a second frequency bandwidth different from the first frequency bandwidth based at least in part on a presence during the first duration of the signal associated with use of the first frequency bandwidth by one or more cellular networks.

5. The WLAN device of claim 4, wherein the one or more processors are individually or collectively further operable to execute the code to cause the WLAN device to:
monitor, after the third duration has elapsed, the first frequency bandwidth for another one or more signals associated with use of the first frequency bandwidth by one or more cellular networks.

6. The WLAN device of claim 4, wherein the one or more processors are individually or collectively operable to execute the code to cause the WLAN device to perform the communications via the second frequency bandwidth based at least in part on the signal associated with use of the first frequency bandwidth by one or more cellular networks having a received power that satisfies a threshold value.

7. The WLAN device of claim 1, wherein the one or more processors are individually or collectively further operable to execute the code to cause the WLAN device to:
detect a periodicity between at least two signals associated with use of the first frequency bandwidth by one or more cellular networks, wherein the one or more processors are individually or collectively operable to execute the code to cause the WLAN device to perform the communications based at least in part on whether the periodicity between the at least two signals indicates use of the first frequency bandwidth by one or more cellular networks.

8. The WLAN device of claim 1, wherein the one or more processors are individually or collectively further operable to execute the code to cause the WLAN device to:
perform the communications via the first frequency bandwidth for at most a fourth duration based at least in part on a presence during the first duration of the signal associated with use of the first frequency bandwidth by one or more cellular networks; and
refrain from performing communications via the first frequency bandwidth after the fourth duration has elapsed.

9. The WLAN device of claim 1, wherein the WLAN device is configured with a set of values corresponding to the first duration associated with a duration for the monitoring, a second duration associated with a time between monitoring occasions, a third duration associated with a non-occupancy period, a fourth duration associated with a time for closing a channel transmission, or any combination thereof.

10. The WLAN device of claim 9, wherein the one or more processors are individually or collectively further operable to execute the code to cause the WLAN device to:
adjust the set of values based at least in part on a time of day, a current date, or both.

11. The WLAN device of claim 9, wherein the one or more processors are individually or collectively further operable to execute the code to cause the WLAN device to:
receive a message indicating one or more updated values corresponding to the set of values; and
update the set of values based at least in part on reception of the message.

12. The WLAN device of claim 1, wherein the one or more processors are individually or collectively further operable to execute the code to cause the WLAN device to:
detect the signal associated with use of the first frequency bandwidth by one or more cellular networks, wherein the signal indicates use of a first channel of the first frequency bandwidth by one or more cellular networks; and
perform the communications via a second channel of the first frequency bandwidth based at least in part on detection of the signal.

13. The WLAN device of claim 12, wherein the signal associated with use of the first channel of the first frequency bandwidth by one or more cellular networks indicates the use of the first channel of the first frequency bandwidth by one or more cellular networks by being transmitted over the first channel.

14. The WLAN device of claim 12, wherein the one or more processors are individually or collectively further operable to execute the code to cause the WLAN device to:
randomly select the second channel from among a set of channels of the first frequency bandwidth that excludes the first channel.

15. The WLAN device of claim 1, wherein the signal associated with use of the first frequency bandwidth by one or more cellular networks comprises a cellular broadcast signal or a beacon signal.

16. A method by a wireless local area network (WLAN) device, comprising:
monitoring, by the WLAN device over a first duration, a first frequency bandwidth for one or more signals associated with use of the first frequency bandwidth by one or more cellular networks;
determining whether a signal associated with use of the first frequency bandwidth by one or more cellular networks is present during the first duration; and
performing, by the WLAN device, communications based at least in part on determining whether the signal associated with use of the first frequency bandwidth by one or more cellular networks is present during the first duration.

17. The method of claim 16, further comprising:
performing the communications via the first frequency bandwidth based at least in part on an absence during the first duration of the signal associated with use of the first frequency bandwidth by one or more cellular networks.

18. The method of claim 17, further comprising:
monitoring, by the WLAN device after a second duration has elapsed, for one or more additional signals associated with use of the first frequency bandwidth by one or more cellular networks; and
determining whether to continue performing the communications via the first frequency bandwidth based at least in part on whether an additional signal associated with use of the first frequency bandwidth by one or more cellular networks is present.

19. The method of claim 16, further comprising:
performing, by the WLAN device for at least a third duration, the communications via a second frequency bandwidth different from the first frequency bandwidth based at least in part on a presence during the first duration of the signal associated with use of the first frequency bandwidth by one or more cellular networks.

20. A non-transitory computer-readable medium storing code for wireless communication by a wireless local area network (WLAN) device, the code comprising instructions executable by one or more processors to:
monitor, by the WLAN device over a first duration, a first frequency bandwidth for one or more signals associated with use of the first frequency bandwidth by one or more cellular networks;
determine whether a signal associated with use of the first frequency bandwidth by one or more cellular networks is present during the first duration; and
perform, by the WLAN device, communications based at least in part on determining whether the signal associated with use of the first frequency bandwidth by one or more cellular networks is present during the first duration.
